(19) United States
(12) Patent Application Publication
(10) Pub. No.: US 2020/0307065 A1
(43) Pub. Date: Oct. 1, 2020

(54) METHOD FOR FORMING A SHEET-LIKE SUBSTRATE

(71) Applicant: Dätwyler Schweiz AG, Schattdorf (CH)

(72) Inventors: Maria Del Mar DIEZ DIAZ, Freienbach (CH); Norbert HABERLAND, Euskirchen (DE); Ronny VRIJENS, Vliermaalroot (BE)

(73) Assignee: Dätwyler Schweiz AG, Schattdorf (CH)

(21) Appl. No.: 16/754,938

(22) PCT Filed: Sep. 25, 2018
(86) PCT No.: PCT/EP2018/075934

§ 371 Date: Apr. 9, 2020

(30) Foreign Application Priority Data
Oct. 11, 2017 (CH) 01242/17

(51) Int. Cl. B29C 51/08; B42D 25/41; B42D 25/425; F16J 3/02

(52) U.S. Cl. CPC B29C 51/082; B42D 25/41; B29L 2031/755; F16J 3/02; B42D 25/425

(57) ABSTRACT

The invention relates to a method for forming a dimensionally stable three-dimensional shape into a sheet-like substrate (3) of thermoplastic material comprising the steps of: a.) providing a mould including a first die (1) with a first template surface (11) for contacting an upper surface (31) of the substrate (3) and a second die (2) with a second template surface (21) for contacting a lower surface (32) of the substrate (3) opposite the upper surface (31) of the substrate (3); each template surface (11, 21) having an inverse of a desired shape to be transformed to the upper and lower surfaces (31, 32) of the substrate (3); and at least one of the first die (1) and the second die (2) being transparent to electromagnetic waves of a predetermined wavelength; b.) providing at least one absorption layer (5, 5′) being able to be heated by absorption of an electromagnetic irradiation (4, 4′) of the predetermined wavelength and thereby heating the thermoplastic substrate (3) to or above its glass transition temperature; c.) placing the substrate (3) between the first and the second die (1, 2) of the mould and closing the mould; d.) irradiating the absorption layer (5, 5′) with the electromagnetic irradiation (4, 4) in order to heat the thermoplastic substrate (3) to or above its glass transition temperature during a sufficient time to transform the thermoplastic substrate into the three-dimensional shape.

### TECHNICAL FIELD

The invention refers to a method for forming a dimensionally stable three-dimensional shape into a sheet-like substrate of thermoplastic material.

### BACKGROUND

Thin plastic films with specific three-dimensional features may be used e.g. as control diaphragms for diaphragm carburettors. An example of such a diaphragm is described in WO2016012233 or Swiss patent application No. 00038/16. The diaphragm comprises a dimensionally stable three-dimensional shape in the form of a plurality of concentric corrugations.

Sheet-like substrates are typically processed by thermoforming manufacturing techniques such as vacuum or pressure thermoforming or mechanical thermoforming using a male and female die. However, vacuum or pressure thermoforming is only suitable for cup-like structures and very fine accurate structures on both sides of the sheet cannot be obtained. With mechanical thermoforming such as matched mould forming or hot embossing finer structures are obtainable. However, to accurately form plastic two-dimensional, planar sheets or films with less than 100 micrometre thickness into a dimensionally stable three-dimensional shape is hardly possible.

Furthermore, the thermoforming with matching moulds or hot embossing are costly and have long cycle-times due to long heating and cooling cycles of the mould, because the entire mould is preheated to a glass transition temperature or above of the thermoplastic material during each cycle. This is especially true for thermal processing of plastics with high glass transition temperatures.

A further problem of the known thermoforming techniques is that they are not suitable to manufacture diaphragms with structural features of different thicknesses e.g. a thickened central part which is up to several times thicker than the remaining area of the diaphragm.

Therefore, there is a need for a fast and highly accurate manufacturing method to form a dimensionally stable three-dimensional shape into a sheet-like substrate of thermoplastic material.

### SUMMARY OF THE INVENTION

One aspect of the invention relates to a fast and highly accurate manufacturing method to form a dimensionally stable three-dimensional shape into a sheet-like substrate of thermoplastic material.

A method for forming a sheet-like substrate and a related device are disclosed. The method for forming a dimensionally stable three-dimensional shape into a sheet-like substrate of thermoplastic material comprises the steps of: (a) providing a mould including a first die with a first template surface for contacting an upper surface of the sheet-like substrate and a second die with a second template surface for contacting a lower surface of the sheet-like substrate opposite the upper surface of the sheet-like substrate; each template surface having an inverse of a desired shape to be transformed to the upper and lower surfaces of the substrate; and at least one of the first die and the second die being transparent to electromagnetic waves of a predetermined wavelength; (b) providing at least one absorption layer being able to be heated by absorption of an electromagnetic irradiation of the predetermined wavelength and thereby heating the thermoplastic substrate to or above its glass transition temperature; (c) placing the substrate between the first and the second die of the mould and closing the mould; (d) irradiating the absorption layer with the electromagnetic irradiation in order to heat the thermoplastic substrate to or above its glass transition temperature during a sufficient time to transform the thermoplastic material into the three-dimensional shape.

The method thus allows to form planar sheet-like substrates into non-planar products with dimensionally stable shapes e.g. the diaphragms described in WO2016012233 or Swiss patent application No. 00038/16. The sheet-like substrate may be a sheet, a foil or a film of thermoplastic material. The sheet-like substrate suitable for the method may have a thickness preferably between 5 micrometre to 5 millimetre, preferably 8 to 500 micrometres. Thermoplastic materials may be selected from the group of polybenzimidazole (PBI), polyimide (PI), thermoplastic polyimide (TPI), polyamide imide (PAI), polyethersulfone (PES), polyphenylsulfone (PPSU), polyetherimide (PEI), polysulfone (PSU), polyether ketone (PEK), polyaryl ether ketone (PAEK), polyphenylene sulfide (PPS), perfluoroalkoxy polymer (PFA), ethylenetetrafluoroethylene (ETFE), polychlorotrifluoroethylene (PCTFE), polyvinylidene fluoride (PVDF), polybutylene terephthalate (PBT) or polyetheretherketone (PEEK).

The electromagnetic waves may be emitted from a pulsed source with a wavelength of 200 nm to 2000 nm.

The absorption layer may be a layer of metal provided over the first and/or second template surface. Typically the metal layer will be between a few tens and a few hundreds of nanometres thick. The irradiation source then emits a beam, which passes through the first and/or second die and is incident upon the metal layer. The layer of metal absorbs the beam, and rapidly becomes hot. The portion of the absorption layer, which is in contact with the upper and/or lower surface of the sheet-like substrate transfers heat to the sheet-like substrate, which heats up accordingly to or above its glass transition temperature and the sheet-like substrate is transformed to obtain a dimensionally stable three-dimensional shape.

In the case that more than one absorption layer is provided, the absorption layers may be of different material heatable by the same or by different irradiation wavelength.

With the described method two side moulding of sheet-like substrates is possible.

Preferred embodiments of the invention are also disclosed.

In some embodiments at least one of the first template surface and the second template surface is provided with the absorption layer. In the case that both template surfaces are provided with an absorption layer two sources of irradiation may be used to irradiate both layers through their respective transparent die.

In some embodiments the sheet-like substrate is provided with the absorption layer. Such a layer may be coated onto the sheet-like substrate or may be the sheet-like substrate itself.

In some embodiments the sheet-like substrate may be transparent to electromagnetic waves of the predetermined wavelength.

In some embodiments the sheet-like substrate may comprise a material suitable to absorb the electromagnetic irradiation of predetermined wavelength in order to be heated to or above its glass transition temperature.

In some embodiments the sheet-like substrate may comprise at least two parts, preferably two layers. During step d, the at least two parts may be melted together.

In some embodiments the absorption layer may be provided only to regions where the sheet-like substrate is to be melted.

In some embodiments the surface of the sheet-like substrate may be provided with a release coating prior to step c, in order to facilitate demoulding. The release coating may be a hydrophobic coating. The coating may be a fluorinated coating e.g. a fluorinated ethylene propylene coating. The coating may be in the range of 10 nm.

The invention further refers to a device for forming a dimensionally stable three-dimensional shape into a sheet-like substrate of thermoplastic material, the device comprising: (a) a mould including a first die with a first template surface for contacting an upper surface of the substrate and a second die with a second template surface for contacting a lower surface of the substrate opposite the upper surface of the substrate; each template surface having an inverse of a desired shape to be transformed to the upper and lower surfaces of the substrate; and at least one of the first die and the second die being transparent to electromagnetic waves of a predetermined wavelength; and (b) a source of electromagnetic irradiation of the predetermined wavelength in order to heat an absorption layer arranged between the first template surface and the second template surface.

The source of electromagnetic waves may be a pulsed source with a wavelength of 200 nm to 2000 nm.

In some embodiments at least one of the first template surface and the second template surface may be provided with the absorption layer.

In some embodiments the absorption layer may be a single layer. The absorption layer may be a metallic layer, a graphite layer or a layer of heat absorbing paint.

### BRIEF EXPLANATION OF THE FIGURES

The invention is described in greater detail below with reference to embodiments that are illustrated in the figures. The figures show:

FIGS. 1A-1C schematic representations of a method for forming a dimensionally stable three-dimensional shape into a sheet-like substrate of thermoplastic material;

FIG. 2 a schematic representation of the mould during irradiation from one side;

FIG. 3 a schematic representation of the mould during irradiation from both sides;

FIG. 4 a schematic representation of the method with the absorption layer provided on the substrate;

FIG. 5 a diaphragm manufacturable by the method of FIG. 1;

FIGS. 6A-6B schematic representations of a method for forming a dimensionally stable three-dimensional shape into a sheet-like substrate of thermoplastic material including bonding of two layers.

### DESCRIPTION OF THE INVENTION

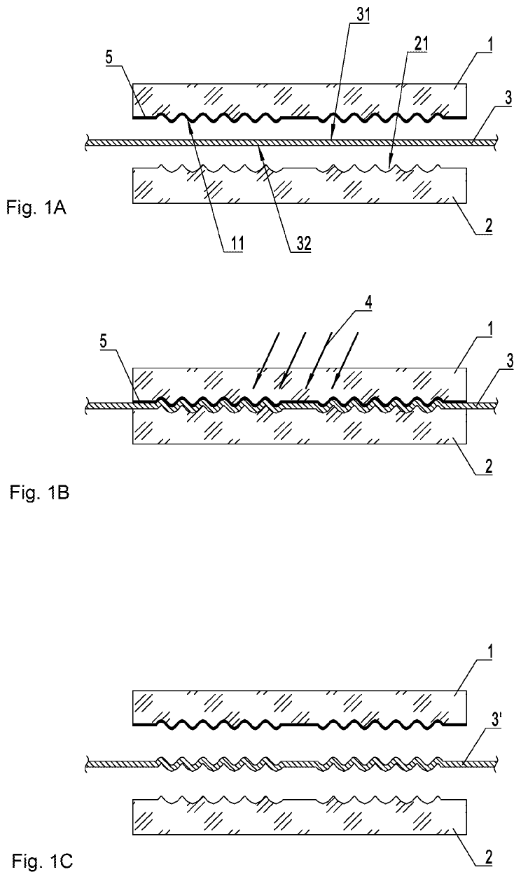

FIGS. 1A-1C show schematic representations of a method for forming a dimensionally stable three-dimensional shape into a sheet-like substrate 3 of thermoplastic material.

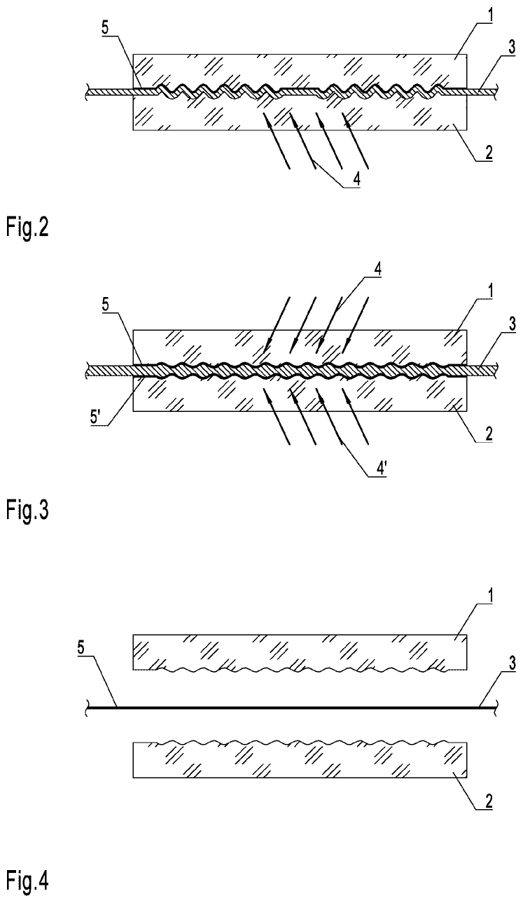

FIG. 1A shows an open mould with a first die 1 having a first template surface 11 and a second die 2 having a second template surface 21. The first template surface 11 having the inverse shape of the desired three-dimensional structure to be formed into an upper surface 31 of the sheet-like substrate 3. The second template surface 21 having the inverse shape of the desired three-dimensional structure to be formed into a lower surface 32 of the sheet-like substrate 3. The first and second template surfaces 11, 21 may have complementary shapes as shown in FIGS. 1A-1C and FIG. 2. However, non-complementary shapes are also possible as long as the thermoplastic material can be sufficiently displaced in its molten state, as shown in FIG. 3 and FIG. 4.

The sheet-like substrate 3 may be planar sheet, foil or film having a thickness in the range of 5 to 5000 micrometres, preferably 25 to 500 micrometres, and is placed between the first and the second die 1, 2. With respect to the present invention the sheet-like substrate before applying the method is two-dimensional. Afterwards it has a dimensionally stable three-dimensional shape e.g. with complementary corrugations to obtain e.g. a diaphragm with approximately the same overall thickness (FIG. 1C) or non-complementary corrugations (FIG. 3) to obtain e.g. a diaphragm with changing thickness.

Good results have been achieved so far with a 25 micrometer film of poly ether ether ketone (PEEK). However, thicker films and other materials, such as polybenzimidazole (PBI), polyimide (PI), thermoplastic polyimide (TPI), polyamide imide (PAI), polyethersulfone (PES), polyphenylsulfone (PPSU), polyetherimide (PEI), polysulfone (PSU), polyether ketone (PEK), polyaryl ether ketone (PAEK), polyphenylene sulfide (PPS), perfluoroalkoxy polymer (PFA), ethylenetetrafluoroethylene (ETFE), polychlorotrifluoroethylene (PCTFE), polyvinylidene fluoride (PVDF) or polybutylene terephthalate (PBT) may also be used.

In the method shown in FIGS. 1A-1C the first template surface 11 of the first die 1 is provided with an absorption layer 5. The absorption layer 5 can be quickly heated within milliseconds by electromagnetic irradiation 4 of a wavelength in the range of 200 to 2000 nm from a pulsed source. In order to irradiate the absorption layer 5, the first die 1 is of a material transparent to the wavelength of the electromagnetic irradiation 4.

After or during closure of the mould (FIG. 1B), the absorption layer 5 absorbs the irradiation 4 and is quickly heated up in order to transfer the energy to the thermoplastic sheet-like substrate 3. The substrate 3 is thereby heated until it is sufficiently hot, typically to or above its glass transition temperature, to be transformed into the desired three-dimensional shape. During the process the first and/or second die 1, 2 of the mould hardly heat up and almost immediately after stopping the irradiation 4 the mould can be opened and the transformed sheet-like substrate 3′ can be removed (see FIG. 1C). The mould is then ready for the next cycle.

Alternatively to the embodiment shown in FIGS. 1A-1C, the second die 2 and the sheet-like substrate 3 may be transparent to the irradiation. In this case the irradiation can pass through the second die 2 and the substrate 3 to the absorption layer 5 provided on the first die 1, as shown in FIG. 2.

In order to process thicker sheet-like substrates, both the first and the second template surfaces 11, 21 may each be provided with an absorption layer 5, 5′. In this case both the first and second die 1, 2 are transparent and the absorption layers 5, 5′ are irradiated from opposite sides, as shown in FIG. 3.

FIG. 4 shows a variation of the method where the sheet-like substrate 3 itself is provided with an absorption layer 5 coated onto the substrate on one side or both sides or the substrate is of thermoplastic material that absorbs the irradiation. The first and/or the second die 1, 2 are transparent and the irradiation can be directed onto the substrate from one or both sides.

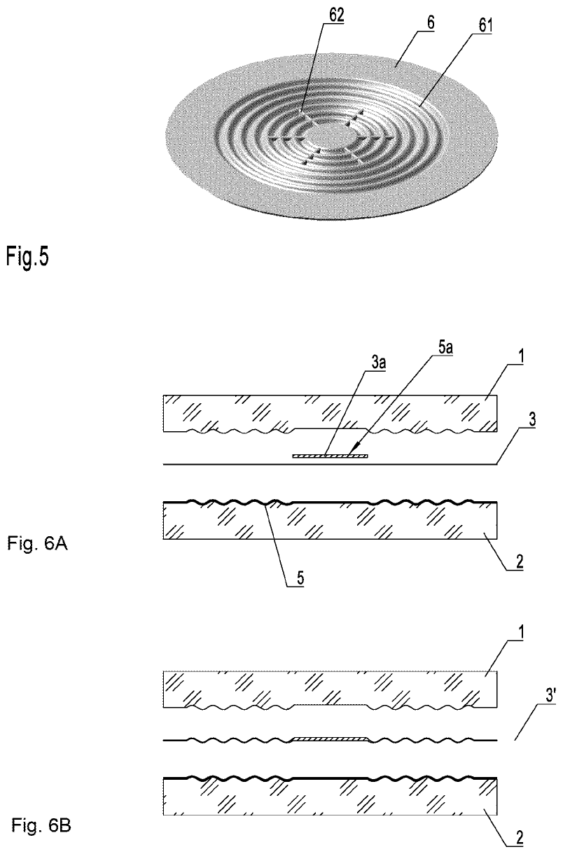

FIG. 5 shows an example of an article that may be manufactured with the method according to the invention. The article is a diaphragm 6 made of thermoplastic film material as it is described in WO2016012233. The diaphragm 6 in form of a disc comprises a plurality of concentric corrugations 61 and radial reinforcing ribs 62. Such a three-dimensional structure may be obtained by the methods described above. Good results have been achieved e.g. with a planar 25 micrometre thick PEEK film, into which a plurality of circular, concentric corrugations such as shown in the diaphragm of FIG. 5 have been formed.

As shown in FIGS. 6A-6B, the method further allows to bond two or more layers of substrate 3, 3a together. FIG. 6A shows the mould in the open state before transforming the substrates 3, 3a. FIG. 6B shows the mould in the open state after transforming the substrate to a substrate with dimensionally stable three-dimensional shape 3′. In order to obtain e.g. a diaphragm with a plurality of concentric corrugations and an central part, which is several times thicker than the corrugated diaphragm, a separate part 3a of substrate can be placed centrally on the sheet-like substrate 3, as indicated in FIG. 6A, or placed in one of the two dies 1, 2. An example of such a diaphragm is described in Swiss patent application No. 00038/16.

The separate part 3a may be constituted as an absorption layer 5a or may be provided with an absorption layer 5a on either side. During irradiation of the absorption layer(s) 5, 5a the two substrate parts 3, 3a are heated above the glass transition temperature of the thermoplastic material and thereby permanently bonded together and a dimensionally stable three-dimensional shape is formed into the sheet-like substrate 3, as shown in FIG. 6B.

It is understood that the present invention is not limited to the embodiments as discussed above. The person skilled in the art will be able to derive further variants with knowledge of the invention which also belong to the subject matter of the present invention.

### REFERENCE SIGNS

1 first die
11 first template surface
2 second die
21 second template surface
3 sheet-like substrate
3a part of sheet-like substrate
3′ transformed sheet-like substrate
31 upper surface
32 lower surface
4, 4′ electromagnetic irradiation
5, 5′ absorption layer
5a absorption layer
6 diaphragm
61 concentric corrugations
62 radial ribs

1-11. (canceled)

12. A method for forming a dimensionally stable three-dimensional shape into a sheet-like substrate of a thermoplastic material, the method comprising:
providing a mould including a first die with a first template surface for contacting an upper surface of the substrate and a second die with a second template surface for contacting a lower surface of the substrate opposite the upper surface of the substrate;
each template surface having an inverse of a desired shape to be transformed to the upper and lower surfaces of the substrate; and at least one of the first die and the second die being transparent to electromagnetic waves of a predetermined wavelength;
providing at least one absorption layer being able to be heated by absorption of an electromagnetic irradiation of the predetermined wavelength and thereby heating the thermoplastic substrate to or above a glass transition temperature of the thermoplastic substrate;
placing the substrate between the first and the second die of the mould and closing the mould;
irradiating the absorption layer with the electromagnetic irradiation to heat the thermoplastic substrate to or above the glass transition temperature during a sufficient time to transform the thermoplastic substrate into the three-dimensional shape.

13. The method according to claim 12, wherein at least one of the first template surface and the second template surface is provided with the absorption layer.

14. The method according to claim 12, wherein the sheet-like substrate is provided with the absorption layer.

15. The method according to claim 12, wherein the sheet-like substrate comprises a material suitable to absorb the electromagnetic irradiation of the predetermined wavelength and forms the absorption layer in order to be heated to or above the glass transition temperature.

16. The method according to claim 12, wherein the sheet-like substrate comprises at least two parts.

17. The method according to claim 16, wherein the at least two parts are melted together during the step of irradiating the absorption layer.

18. The method according to claim 12, wherein the absorption layer is provided only to regions where the sheet-like substrate is to be melted.

19. The method according to claim 12, wherein the surface of the sheet-like substrate is provided with a hydrophobic coating prior to placing the substrate between the first and second die.

20. A device for forming a dimensionally stable three-dimensional shape into a sheet-like substrate of thermoplastic material, the device comprising:
a mould including a first die with a first template surface for contacting an upper surface of the substrate and a second die with a second template surface for contacting a lower surface of the substrate opposite the upper surface of the substrate, each template surface having an inverse of a desired shape to be transformed to the upper and lower surfaces of the substrate, and at least one of the first die and the second die being transparent to electromagnetic waves of a predetermined wavelength;
a source of electromagnetic irradiation of the predetermined wavelength in order to heat an absorption layer arranged between the first template surface and the second template surface.

21. The device according to claim 20, wherein at least one of the first template surface and the second template surface is provided with the absorption layer.

22. The device according to claim 20, wherein the absorption layer is a metallic layer, a graphite layer or a layer of heat absorbing paint.
